(19) United States
(12) Patent Application Publication
(10) Pub. No.: US 2010/0230267 A1
(43) Pub. Date: Sep. 16, 2010

(54) PUSH SWITCH

(75) Inventors: Masahiro Masuda, Okayama (JP); Yoshikazu Yagi, Okayama (JP); Koji Tamano, Osaka (JP)

Correspondence Address: RATNERPRESTIA, P.O. BOX 980, VALLEY FORGE, PA, 19482, US

(73) Assignee: Panasonic Corporation, Osaka (JP)

(21) Appl. No.: 12/719,357

(22) Filed: Mar. 8, 2010

(30) Foreign Application Priority Data
Mar. 12, 2009 (JP) 2009-059075

(51) Int. Cl. H01H 13/14

(52) U.S. Cl. 200/520

(57) ABSTRACT

A push switch includes: an operation portion which is pushed and operated from a direction parallel to a surface of the mounted printed circuit board; a plurality of contacts which are electrically conducted to each other by the push operation of the operation portion; a case which is formed from an insulation body and has a lower surface facing the printed circuit board; a plurality of terminals which are led out from the case to outside; and a embedded portion which is physically and electrically connected to any one of the terminals and embedded and fixed inside the case. An exposed portion is formed in a part of the embedded portion so as to be exposed to the outside from the lower surface of the case. Soldering strength is improved without increasing an occupied area of the push switch on the printed circuit board.

### BACKGROUND OF THE INVENTION

1. Field of the Invention

The present invention relates to a push switch which is mounted on an printed circuit board of an electronic apparatus by soldering and pushed from a direction parallel to an printed circuit board surface to be operated.

2. Description of Related Art

Recently, as electronic apparatuses are reduced in size and thickness, operation buttons are provided on side surfaces of the electronic apparatuses in many cases. Accordingly, a horizontal-push-type push switch which is pushed and operated from a direction parallel to an printed circuit board surface is frequently used as the operation buttons.

The construction of a conventional push switch will be described with reference to FIGS. 8 to 12.

FIG. 8 is a cross-sectional view of the conventional push switch. FIG. 9 is an exploded perspective view of the conventional push switch. FIG. 10 is a plan view of a case of the conventional push switch. FIG. 11 is a cross-sectional view of the conventional push switch taken along a line 11-11 of FIG. 10.

Case 1 formed from insulation resin has a substantially rectangular shape, and includes substantially circular concave portion 1A formed on the upper surface thereof. Central fixed contact 2 is arranged at the center of the internal bottom surface of concave portion 1A, and two outer fixed contacts 3 which are electrically insulated from central fixed contact 2 are arranged at two point-symmetric positions with central fixed contact 2 set to the center. Additionally, central fixed contact 2 and outer fixed contacts 3 are connected to terminals 104 and 5, respectively, which are led out to the outside of case 1.

That is, outer fixed contacts 3 are physically and electrically connected to terminal 5, which is exposed to the same plane as the lower surface of case 1 near the side wall of case 1 and horizontally led out, through embedded portion 3A which is exposed to the internal bottom surface of concave portion 1A of case 1 and embedded inside the insert-molded insulation resin. Similarly, central fixed contact 2 is physically and electrically connected to terminal 104, which is exposed to the same plane as the lower surface of case 1 and horizontally led out, through embedded portion 2A inside the insert-molded insulation resin.

Movable contact 6 is formed from an elastic metallic thin plate and has a circular dome shape of which the upper part is convex. Movable contact 6 is housed in concave portion 1A of case 1 such that the outer circumference thereof is installed on outer fixed contacts 3 and the lower surface of the central portion having a circular dome shape faces central fixed contact 2 with an interval provided therebetween.

Protective sheet 7 is formed from an insulation film having an adhesive provided on the lower surface thereof and fixed through the adhesive so as to cover the upper surface of concave portion 1A of case 1.

Operation body 8 includes operation portion 8A protruding in a direction the left direction in FIG. 8 in which a push operation is received. Additionally, operation body 8 includes driving portion 8B protruding toward a push direction (the right direction in FIG. 8) and frame-shaped portion 8C provided around driving portion 8B with an interval set therebetween. As frame-shaped portion 8C is loaded on the upper surface of protective sheet 7, operation body 8 may move back and forth.

Cover 9 is formed from a metallic plate and includes inclined portion 9A provided at the center thereof. Inclined portion 9A is cut and bent toward an printed circuit board surface from the push direction. Cover 9 includes engagement portions 9B which are engaged with and fixed to engagement protrusions 1B of case 1 such that the leading end of driving portion 8B of operation body 8 is brought into contact with a surface of inclined portion 9A on the side where the push operation is received.

The operation of the conventional push switch will be described as follows.

First, when operation portion 8A of operation body 8 is pushed in the push direction, operation body 8 is moved on protective sheet 7 in the push direction. Additionally, the leading end of driving portion 8B brought into contact with inclined portion 9A of cover 9 is obliquely guided and moved along the inclined surface toward the printed circuit board surface.

Then, the pushing force is applied to the central portion of movable contact 6 through protective sheet 7 by the movement of the leading end of driving portion 8B. Therefore, when the pushing force exceeds a predetermined magnitude, movable contact 6 is elastically inverted with a click feeling. As a result, the lower surface of the central portion comes in contact with central fixed contact 2 facing the lower surface such that outer fixed contacts 3 and central fixed contact 2 are electrically conducted through movable contact 6. Accordingly, terminals 104 and 5 led out to the outside are electrically conducted (switched on).

When the push operation of operation portion 8A is released, movable contact 6 elastically recovers to the original shape of which the upper portion is convex with a click feeling due to a self-recovery force. As a result, the lower surface of the central portion is separated from central fixed contact 2 such that outer fixed contacts 3 and central fixed contact 2 are insulated (switched off). Additionally, since a biasing force caused by the recovery force of movable contact 6 is applied to the leading end of driving portion 8B through protective sheet 7, the leading end is guided obliquely upward along the inclined surface of inclined portion 9A, and operation body 8 is pushed to return to the original position shown in FIG. 8 before the push operation is performed.

FIG. 12 is an external view explaining a mounting state of the push switch.

A plurality of lands 12 for soldering terminals 104 and 5 of the push switch are arranged on the surface of printed circuit board 111 on which the push switch is mounted. That is, as respective terminals 104 and 5 of the push switch are installed on lands 12 so as to be soldered and fixed thereto, operation portion 8A of operation body 8 protrudes from an end portion of the printed circuit board 111.

Japanese Patent Unexamined Publication No. 2007-329022 is known as a related art document according to the invention of this application.

However, since the integration degree of electric parts mounted on an printed circuit board increases as electric apparatuses are reduced in size and thickness and multifunctioned, a push switch with the small outer shape is demanded. Additionally, it is desirable to develop a push switch of which the soldering strength is improved to prevent the push switch from being separated from the printed circuit board, even when an unexpected large force is applied to the operation portion.

### SUMMARY OF THE INVENTION

According to an aspect of the invention, a push switch mounted on an printed circuit board includes: an operation portion which is pushed and operated from a direction parallel to a surface of the printed circuit board; a plurality of contacts which are electrically conducted to each other by the push operation of the operation portion; a case which is formed from an insulation body and has a lower surface facing the printed circuit board; a plurality of terminals which are led out from the case to outside; and a embedded portion which is physically and electrically connected to any one of the terminals and embedded and fixed inside the case. An exposed portion is formed in a part of the embedded portion so as to be exposed to the outside from the lower surface of the case.

Accordingly, it is possible to improve the soldering strength without increasing an area occupied by the push switch on the printed circuit board.

### BRIEF DESCRIPTION OF THE DRAWINGS

FIG. 1 is a cross-sectional view of a push switch according to an embodiment of the invention.

FIG. 2 is an exploded perspective view of the push switch according to the embodiment of the invention.

FIG. 3 is a plan view of a case of the push switch according to the embodiment of the invention.

FIG. 4 is a cross-sectional view of the push switch according to the embodiment of the invention, taken along a line 4-4 of FIG. 3.

FIG. 5 is a cross-sectional view explaining the operation of the push switch according to the embodiment of the invention.

FIG. 6 is an external view explaining a mounting state of the push switch according to the embodiment of the invention.

FIG. 7 is an external view explaining a mounting state of a push switch according to another embodiment of the invention.

FIG. 8 is a cross-sectional view of a conventional push switch.

FIG. 9 is an exploded perspective view of the conventional push switch.

FIG. 10 is a plan view of a case of the conventional push switch.

FIG. 11 is a cross-sectional view of the conventional push switch taken along a line 11-11 of FIG. 10.

FIG. 12 is an external view explaining a mounting state of the conventional push switch.

### DETAILED DESCRIPTION OF THE PREFERRED EMBODIMENTS

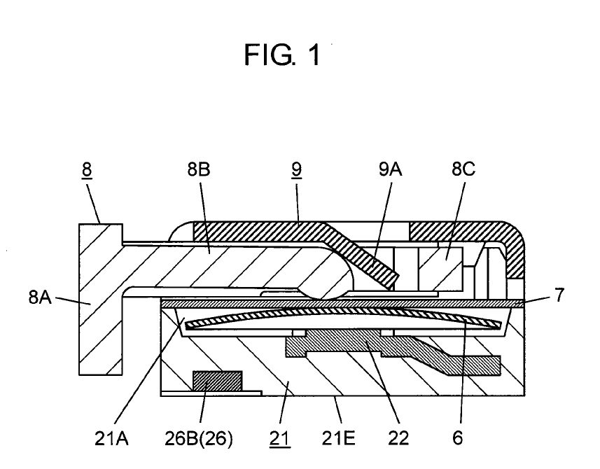

Hereinafter, preferred embodiments of the invention will be described with reference to FIGS. 1 to 7. Throughout the disclosure, like reference numerals refer to the same components as those of the construction described in the related art, and the detailed descriptions thereof will be omitted.

First, the construction of a push switch according to an embodiment of the invention will be described.

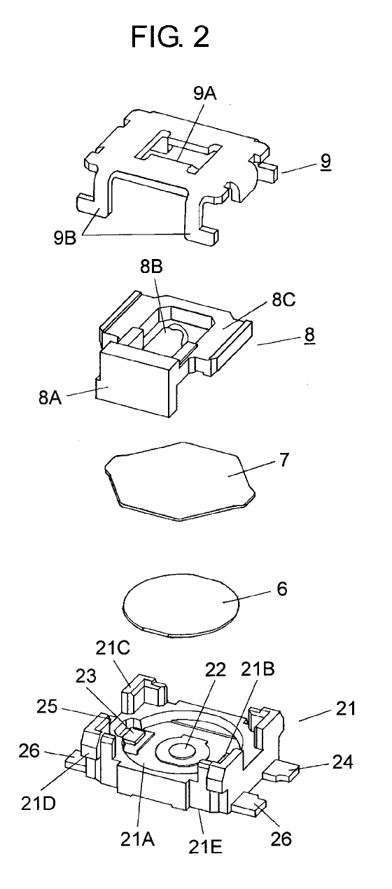

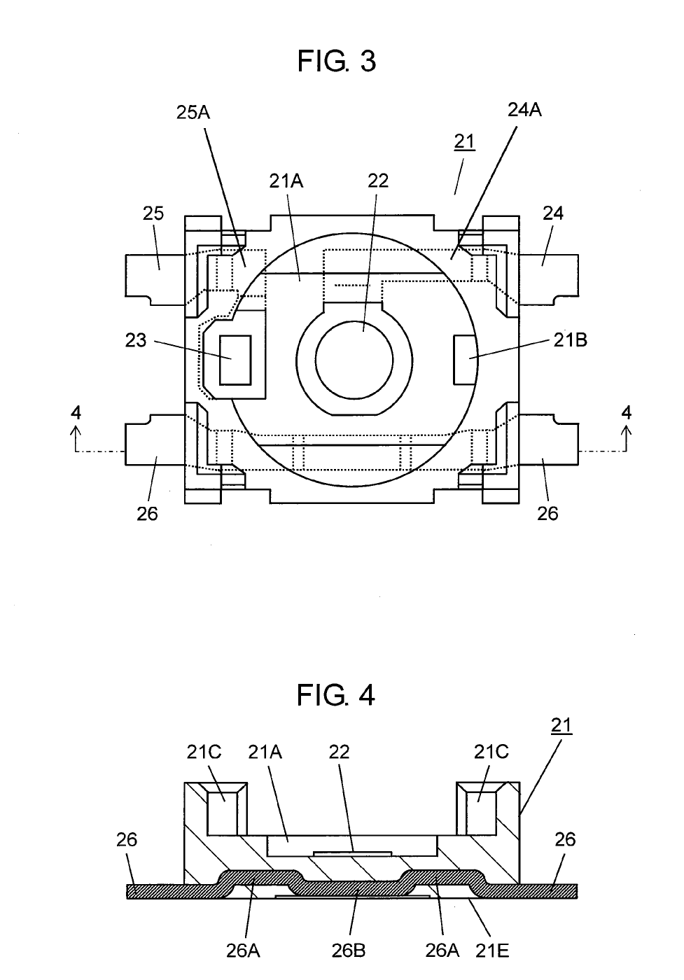

FIG. 1 is a cross-sectional view of the push switch according to the embodiment of the invention. FIG. 2 is an exploded perspective view of the push switch according to the embodiment of the invention. FIG. 3 is a plan view of a case of the push switch according to the embodiment of the invention. FIG. 4 is a cross-sectional view of the push switch according to the embodiment of the invention, taken along a line 4-4 of FIG. 3.

Case 21 formed from insulation resin has a substantially rectangular shape and includes circular concave portion 21A formed on the upper surface thereof. Central fixed contact 22 is arranged at the center of the internal bottom surface of concave portion 21A, and outer fixed contact 23 which is electrically insulated from central fixed contact 22 is arranged at a position separated from central fixed contact 22.

On the opposite side of outer fixed contact 23, which is point-symmetric with outer fixed contact 23 with central fixed contact 22 set to the center, receiving portion 21B having the same height as that of outer fixed contact 23 is provided.

Case 21 includes L-shaped protrusion portion 21C provided at each corner on the upper surface thereof, protrusion portion 21C protruding upwardly in an L shape. Engagement protrusion 21D is provided on each outer side surface of L-shaped protrusion portion 21C.

Terminal 24 is led out from case 21 to outside. Terminal 24 is physically and electrically connected to central fixed contact 22 through embedded portion 24A which is insert-molded and fixed inside insulation resin of case 21. Similarly, terminal 25 is led out from case 21 to outside. Terminal 25 is physically and electrically connected to outer fixed contact 23 through embedded portion 25A which is insert-molded and fixed inside the insulation resin of case 21. Additionally, two earth terminals 26 are led out from case 21 to outside. These earth terminals 26 are physically and electrically connected to each other through embedded portion 26A which is insert-molded and fixed inside the insulation resin of case 21.

FIG. 4 shows a state in which two earth terminals 26 are connected through embedded portion 26A inside the insulation resin of case 21. Embedded portion 26A inside the insulation resin is bent in a direction separated from lower surface 21E toward the inside of the insulation resin from the led-out portions of two earth terminals 26 on lower surface 21E of case 21. One surface of embedded portion 26A is partially bent again at an intermediate position of embedded portion 26A so as to be exposed to the outside from lower surface 21E of case 21. The bent portion becomes exposed portion 26B.

Exposed portion 26B has recess 70 which is slightly recessed with respect to lower surface 21E of case 21, and the depth of recess 70 is set to such a depth that is suitable to a soldering state during mounting, which will be described below.

Movable contact 6 is formed from an elastic metallic thin plate having a circular shape and has a dome shape of which the upper part is convex. Movable contact 6 is housed in concave portion 21A of case 21. Additionally, the lower end of the outer circumference of movable contact 6 is mounted on outer fixed contact 23 and receiving portion 21B, and the lower surface of the central portion of movable contact 6 faces central fixed contact 22 with an interval provided therebetween.

Protective sheet 7 is formed from an insulation film and fixed to case 21 through an adhesive so as to cover concave portion 21A of case 21. Protective sheet 7 serves to protect movable contact 6, central fixed contact 22, and outer fixed contact 23 inside concave portion 21A from dust.

Operation body 8 includes operation portion 8A protruding in a direction in which an push operation is received, driving portion 8B provided on the opposite side of operation portion 8A and protruding in a rod shape, and frame-shaped portion 8C surrounding driving portion 8B with an interval provided therebetween. Frame-shaped portion 8C is partially loaded on protective sheet 7. Therefore, while operation portion 8 is guided inside L-shaped protrusion portions 21C of case 21, the movement range of operation portion 8 is limited to the push operation direction.

Cover 9 is formed from a metallic plate and has inclined portion 9A formed at the center thereof. Inclined portion 9A is cut and bent toward an printed-circuit-board-surface direction in the push direction. Inclined portion 9A limits the movement of operation body 8 in the reverse direction to the printed-circuit-board-surface direction. Cover 9 includes engagement portion 9B which is formed at each corner thereof so as to extend toward the printed-circuit-board-surface direction. Engagement portion 9B is engaged with and fixed to engagement protrusion 21D of L-shaped protrusion portion 21C of case 21 such that the leading end of driving portion BE of operation body 8 is brought into contact with a surface of inclined portion 9A where the push operation is received.

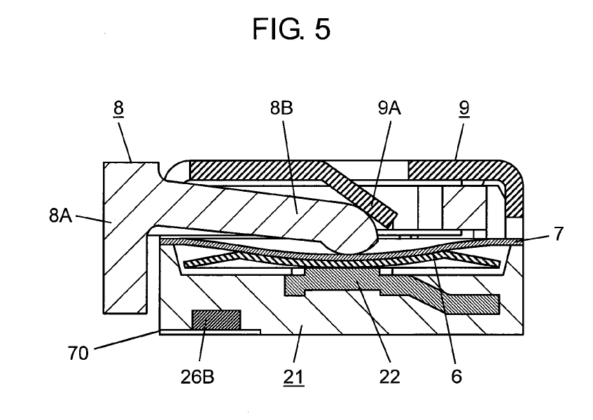

Now, the operation of the push switch according to the embodiment of the invention will be described. FIG. 5 is a cross-sectional view explaining the operation of the push switch according to the embodiment of the invention.

First, when operation portion 8A is pushed down, operation body 8 is moved in the push direction. Then, driving portion 8B is moved while the leading end thereof is guided obliquely downward along inclined portion 9A of cover 9. As a result, driving portion 8B pushes down the central portion of movable contact 6 through protective sheet 7. Additionally, when the pushing force exceeds a predetermined force, movable contact 6 is elastically inverted with a click feeling. Then, the lower surface of the central portion of movable contact 6 comes in contact with central fixed contact 22 positioned under movable contact 6. Accordingly, outer fixed contact 23 and central fixed contact 22 are electrically conducted, and terminals 24 and 25 led out to the outside are electrically conducted (switched on).

When the pushing force applied to operation portion 8A is released, movable contact 6 elastically recovers to the original convex shape with a click feeling due to a self-recovery force thereof. As a result, since the lower surface of the central portion is separated from central fixed contact 22, outer fixed contact 23 and central fixed contact 22 are electrically insulated (switched off). Then, the recovery force of movable contact 6 toward the upward direction is applied to the leading end of driving portion 8B through protective sheet 7 such that the leading end of driving portion 8B is pushed up while being guided obliquely upward along inclined portion 9A. Therefore, operation body 8 is pushed to return to the original position before the push operation, that is, the original state of FIG. 1.

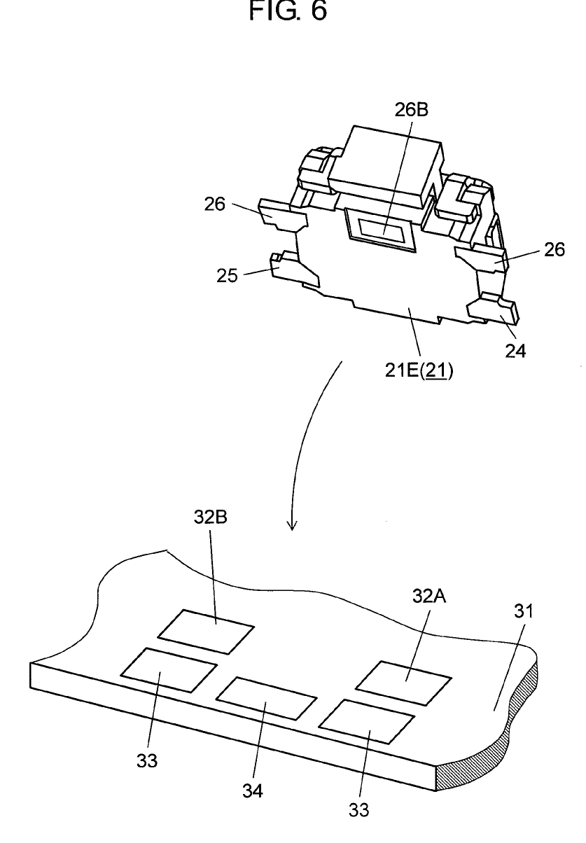

Next, the mounting state of the push switch according to the embodiment of the invention will be described. FIG. 6 is an external view explaining the mounting state of the push switch according to the embodiment of the invention.

Printed circuit board 31 includes lands 32A, 32B, 33, and 34 arranged at predetermined positions on a surface thereof on which the push switch is mounted. The push switch is loaded on the respective lands so as to be mounted by soldering. Land 32A is used for soldering terminal 24 which is connected to central fixed contact 22 of the push switch so as to be led out, land 32B is used for soldering terminal 25 which is connected to outer fixed contact 23 so as to be led out, two lands 33 are used for soldering fixed contact 22 and two earth terminals 26 which electrically insulate from fixed contact 23, and land 34 is used for soldering exposed portion 26B.

When an unexpected force is applied to operation portion 8A in the push switch mounted in such a manner, the force is applied to the respective soldered portions of terminals 24 and 25, two earth terminals 26, and exposed portion 26B formed in embedded portion 26A. That is, in the push switch according to the embodiment of the invention, not only terminals 24 and 25 and two earth terminals 26 led out to the left and right sides of case 21 but also exposed portion 26B exposed to the outside from lower surface 21E of case 21 in a part of embedded portion 26A which is physically and electrically connected to two earth terminals 26 are soldered and fixed. Therefore, the total area of the soldered portions increases, which makes it possible to improve the soldering strength.

Additionally, inter-terminal exposed portion 26B is provided in recess 70 which is slightly recessed from lower surface 21E of case 21. Therefore, as molten solder may be interposed in recess 70, the push switch is prevented from floating from printed circuit board 31 after soldering. Additionally, since exposed portion 26B is reliably fixed to land 34, it is possible to more reliably solder the push switch onto printed circuit board 31. The depth of recess 70 of exposed portion 26B may range from 0.01 to 0.08 mm, and more preferably from 0.03 to 0.05 mm.

In the push switch according to the embodiment of the invention, operation portion 8A has a certain height from the surface of printed circuit board 31 in the mounting state. Therefore, when a force is applied to operation portion 8A, the force easily acts in a direction separated from the soldered portions. At this time, a larger force is applied to the soldered portion close to operation portion 8A than the soldered portion distant from operation portion 8A of case 21. On the side of case 21 close to operation portion 8A, however, the soldering area increases in exposed portion 26B of embedded portion 26A of lower surface 21E of case 21 as well as two earth terminals 26 led out to both sides of case 21. Therefore, it is possible to improve the soldering strength. Accordingly, it is possible to resist the force in the separated direction.

In the push switch according to the embodiment of the invention, the embedded portion which is physically and electrically connected to the earth terminals is embedded and fixed inside the insulation resin of the case, and the exposed portion which may be soldered is provided at the intermediate position of the embedded portion. Therefore, it is possible to improve the soldering strength without increasing an area occupied by the push switch on the printed circuit board.

In the push switch according to the embodiment of the invention, two terminals among the terminals corresponding to the terminal positions of the conventional push switch are configured as earth terminals 26 which are electrically independent from the central fixed contact and the outer fixed contact inside the push switch. Additionally, the installation position of exposed portion 26B formed in embedded portion 26A which is physically and electrically connected to the two earth terminals is set close to the side of operation portion 8A. Accordingly, even if static electricity from the human body flows into operation portion 8A, the static electricity is grounded off through terminals 26 close to operation portion 8A. Therefore, it is possible to prevent the static electricity from flowing into an electric circuit. Additionally, lands 33 for the earth terminals adapted to prevent the static electricity may be provided at the land positions of the conventional push switch, and land 34 for exposed portion 26B also may be provided at a position within the area of case 21. Therefore, it is easy to arrange patterns on printed circuit board 31 without increasing the area occupied by the push switch on printed circuit board 31. That is, it is possible to implement a push switch capable of contributing to increasing the degree of freedom in the pattern design and preventing static electricity.

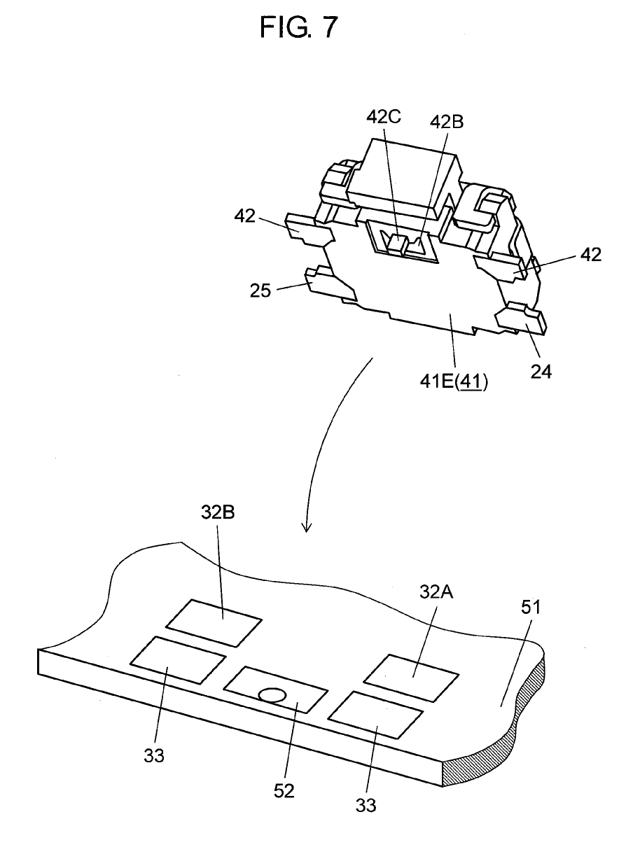

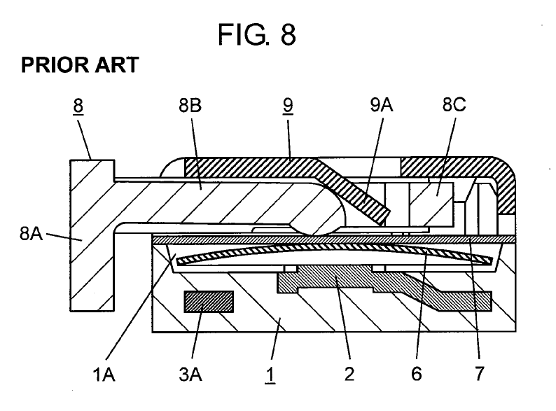

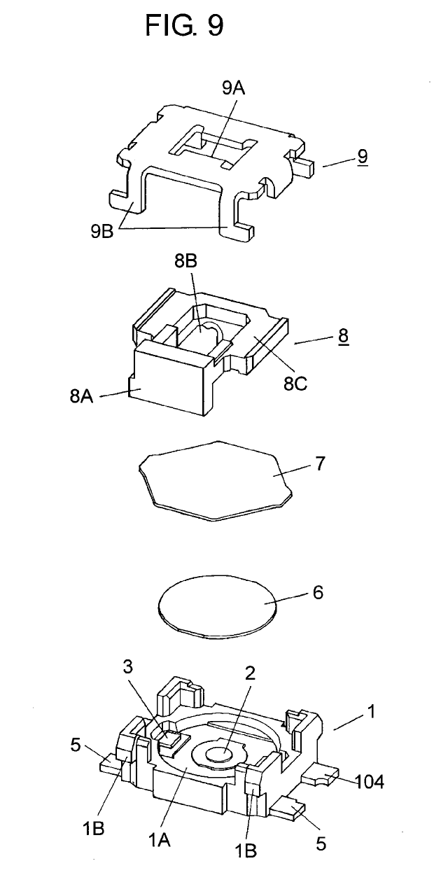

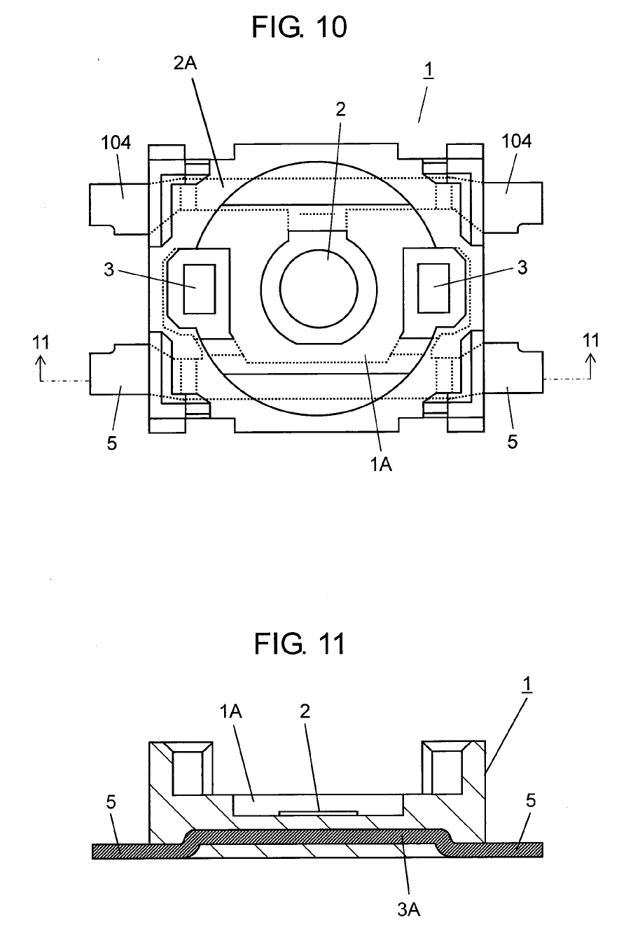

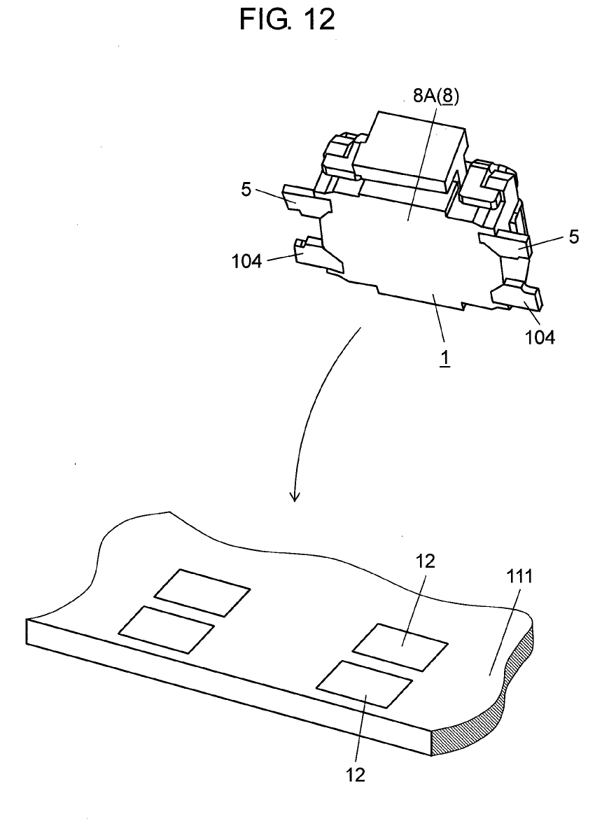

FIG. 7 is an external view explaining the mounting state of a push switch according to another embodiment of the invention.

Protrusion 42C protruding toward the printed circuit board surface is provided in exposed portion 42B at the intermediate position of a embedded portion which is physically and electrically connected to respective terminals 42 of lower surface 41E of case 41. Protrusion 42C is inserted into a through-hole of land 52 provided in an printed circuit board 51, and is soldered along with exposed portion 42B. Accordingly, it is possible to improve the soldering strength without increasing an area occupied by the push switch.

In the above descriptions, the exposed portion is provided in the embedded portion which is physically and electrically connected to the two earth terminals. However, the exposed portion may be provided on the side of signal terminals. Additionally, even when the exposed portion is provided in the embedded portion of the push switch having no earth terminal, the exposed portion may be provided at a position as close as possible to the operation portion of the case. Additionally, the number of exposed portions is not limited to only one, but a plurality of exposed portions may be provided, considering the exterior size of the switch and the routed state of the embedded portion of the terminals. Similarly, the position of the exposed portion is not limited to the central portion as long as the effect of the invention is maintained. Additionally, the shapes and operations of the contacts and the operation portion of the switch are not limited to the above-described construction.

In the embodiments of the present invention, such terms as ‘upper surface’, ‘lower surface’, ‘upward’, and ‘downward’ associated with the directions indicate relative directions depending only on the relative positional relationship among the components of the invention, but do not indicate the absolute upper and lower directions.

1. A push switch mounted on an printed circuit board, comprising:
an operation portion which is pushed and operated from a direction parallel to a surface of the mounted printed circuit board;
a plurality of contacts which are electrically conducted by the push operation of the operation portion;
a case which is formed from an insulation body and has a lower surface facing the printed circuit board;
a plurality of terminals which are led out from the case to outside; and
a embedded portion which is physically and electrically connected to any one of the plurality of terminals and embedded and fixed inside the case,
wherein an exposed portion is formed in a part of the embedded portion so as to be exposed to the outside from the lower surface of the case.

2. The push switch of claim 1,
wherein the exposed portion is formed in the central portion of the embedded portion.

3. The push switch of claim 1,
wherein the exposed portion is an exposed portion to be soldered.

4. The push switch of claim 1,
wherein the exposed portion is recessed more than the lower surface of the case.

5. The push switch of claim 1,
wherein the exposed portion has a protrusion protruding from the lower surface of the case.

6. The push switch of claim 1,
wherein the terminal which is physically and electrically connected to the embedded portion is an earth terminal which is electrically independent from the contacts.

7. The push switch of claim 1,
wherein the embedded portion having the exposed portion formed therein is physically and electrically connected to a terminal provided at the closest position to the side where the operation portion receives the push operation among the plurality of terminals.

8. The push switch of claim 6,
wherein the embedded portion having the exposed portion formed therein is physically and electrically connected to a terminal provided at the closest position to the side where the operation portion receives the push operation among the plurality of terminals.
